(19) United States
(12) Patent Application Publication
(10) Pub. No.: US 2009/0211358 A1
(43) Pub. Date: Aug. 27, 2009

(54) FOOD PREPARATION IMPLEMENT

(76) Inventor: Wayne Bruce Whittle, Largo, FL (US)

Correspondence Address: LARSON AND LARSON, 11199 69TH STREET NORTH, LARGO, FL, 33773, US

(21) Appl. No.: 12/036,054

(22) Filed: Feb. 22, 2008

(51) Int. Cl. G01F 19/00; B65B 25/00

(52) U.S. Cl. 73/427; 426/397

(57) ABSTRACT

An application for a food preparation implement includes a food preparation container having sides and an open end. The open end is adapted to interface with a cutting board. The food preparation container has a liquid barrier on an inner side near a location where the food preparation container interfaces with the cutting board. The liquid barrier forms a liquid-tight barrier preventing prepared food and liquid from exiting the food preparation container while the food preparation container is in use.

### FIELD OF THE INVENTION

This invention relates to the field of culinary arts and more particularly to a device for collecting and measuring food prepared on a cutting board.

### BACKGROUND OF THE INVENTION

Food preparation usually includes reducing a food item into slices, dices, slivers, etc. To prepare the food item, it is often cut into the desired size and shape on a cutting board for several reasons. The primary reason is to prevent damage to the kitchen countertop. Another reason is to allow collection of the prepared food by lifting the cutting board and pushing the prepared food into a bowl or other container. Often, it is difficult to move the prepared food from the cutting board to the target container because the cutting board is a flat surface, usually wider than an opening of the container and the prepared food often does not cooperate, falling over the edge of the cutting board where the container doesn't cover. Furthermore, this situation is worse when the prepared food has a high moisture content such as the case with tomatoes. The liquid often runs off of the cutting board, missing the container.

Various solutions to this problem have been disclosed in prior patents. For example, U.S. Pat. No. 7,178,798 to Funk, et al, describes a cutting board with a raised edge and a channel. The raised edge helps contain the prepared food and the channel helps guide the food into a container. One problem with this solution is the raised edge which interferes with the knife during preparation.

Another such solution is described in U.S. Pat. No. 6,536,763 to Keener. This patent describes a cutting board with a trough. The trough is integrated into the cutting board and is of limited size. Furthermore, being that the trough is beneath the cutting surface, the cutting surface must be raised. Many cooks find it uncomfortable cutting and preparing food at a height that is higher than to which they are accustomed. The same problems exist with the cutting board described in U.S. Pat. No. 6,478,293 to Keener and U.S. Pat. No. 6,371,470 to Ward.

U.S. Pat. No. 6,129,344 to Yang also has a place to catch cut food beneath a cutting board, thereby raising the height of the cutting surface to accommodate the described basket.

U.S. Pat. No. 5,996,983 to Laurenzi has a container for collecting waste. The container is removably attached to a specially designed cutting board, such that the container hangs from the cutting board over the counter edge or sink edge. This configuration requires a specially designed cutting board and that cutting board must be used at the counter or sink edge. The container of this design will interfere with access to the counter, cabinets, drawers and/or sink.

What is needed is a system that will provide a receptacle for prepared food for use with existing cutting boards.

### SUMMARY OF THE INVENTION

In one embodiment, a food preparation implement is disclosed including a food preparation container having sides and an open end. The open end is adapted to interface with a cutting board. The food preparation container has a liquid barrier on an inner side near a location where the food preparation container interfaces with the cutting board. The liquid barrier forms a liquid-tight barrier preventing prepared food and liquid from exiting the food preparation container while the food preparation container is in use.

In another embodiment, a method of preparing food is disclosed including providing a cutting board for cutting the food and providing a food preparation container. The food preparation container has sides and an open end adapted to interface with the cutting board. The food preparation container also has a liquid barrier on an inner side near a location where the food preparation container interfaces with the cutting board. The liquid barrier forms a liquid-tight barrier preventing prepared food and liquid from exiting the food preparation container while the food preparation container is in use. The method continues with cutting food (e.g., chopping, dicing, slicing, etc.) on the cutting board and scraping the food into the food preparation container, whereas the liquid barrier prevents the food and liquid from escaping from the food preparation container.

In another embodiment, a food preparation implement is disclosed including a device for containing prepared food, the device for containing the prepared food has sides and an open end adapted to interface with a cutting board. A device for preventing liquid from escaping from the device for containing the prepared food is located on an inner side near a location where the device for containing prepared food interfaces with the cutting board such that the device for preventing liquid from escaping forms a liquid-tight barrier preventing prepared food and liquid from exiting the device for containing prepared food while in use.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a system of the present invention.

FIG. 2 illustrates a side cut-away view of a first embodiment of the present invention.

FIG. 3 illustrates a side cut-away view of a second embodiment of the present invention.

FIG. 4 illustrates a side cut-away view of a third embodiment of the present invention.

FIG. 5 illustrates a side cut-away view of a fourth embodiment of the present invention.

FIG. 6 illustrates a side cut-away view of a first optional lid of the present invention.

FIG. 7 illustrates a side cut-away view of a second optional lid of the present invention.

FIG. 8 illustrates a side cut-away view of a third optional lid of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Before the present invention, food preparation was performed by cutting or chopping the food on a cutting board, then moving the prepared food to a container, bowl or pot. Often, the prepared food is placed in a measuring cup for measuring its volume before transferring it to the destination container. To transfer the prepared food from the cutting board, the preparer often lifts the cutting board and brushes the prepared food into the destination container using their hand or a knife. Being that the cutting board is often wider than the opening of the destination container, it is difficult to get all of the prepared food into the destination container. Furthermore, when the prepared food has a high moisture content (e.g., tomatoes), excess liquid is difficult to direct into the destination container without spilling.

The present invention overcomes these difficulties and other food preparation problems by providing a container that mates with a typical cutting board, providing an easy transition of the prepared food from the cutting surface into the container. In the preferred embodiments, the container has a ledge to prevent liquids from leaking out and gradients for measuring the amount of prepared food stored within the container.

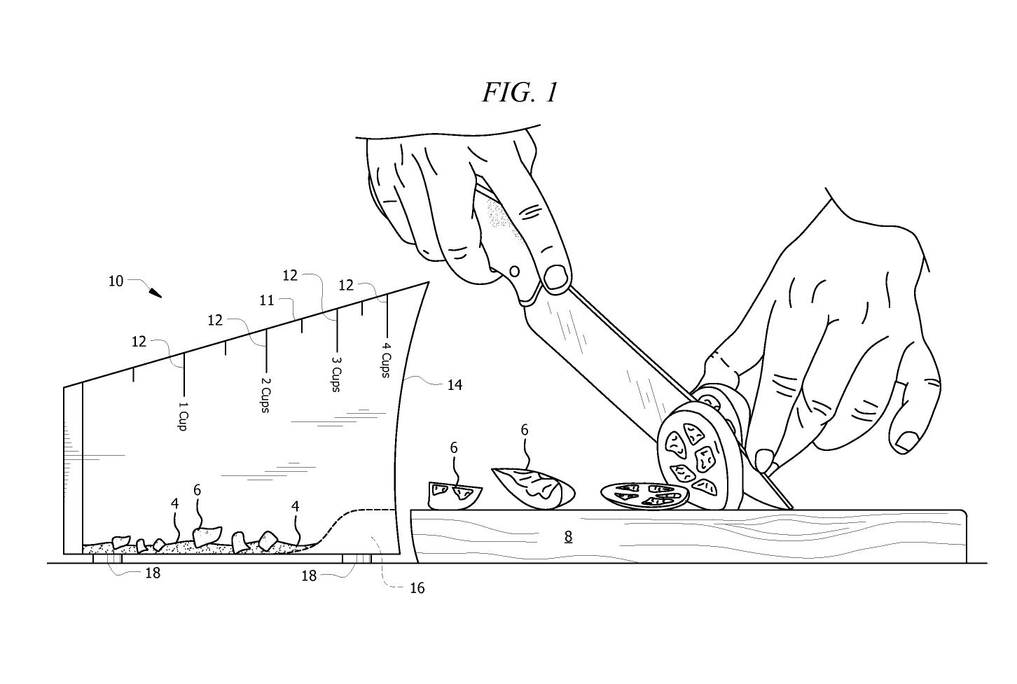

Referring to FIG. 1, a plan view of a system of the present invention is shown. A typical cutting board 8 is shown in use during food preparation. The food preparation implement 10 is shown in position to accept the prepared food 6. In this embodiment, the food preparation container 10 is taller at an end closest to the cutting board 8 as shown by the sloping top edge 11 to provide greater accuracy of measurement for smaller amounts, since the gradients 12 are spaced further apart at the narrow end than at the wide end. As the food 6 is prepared, it is pushed into the food preparation implement 10. Some food 6 is already present in the food preparation implement 10. Note that there is also liquid 4 from the food present in the food preparation implement 10. The liquid barrier 16 helps keep the liquid within the food preparation implement 10 until the contents are poured into another container (not shown). To measure the volume of the food 6 already prepared, the food preparation implement 10 is turned until the opening 14 is in an upward position and the food 6 and liquid 4 on the bottom, whereby the gradients 12 indicate the volume of prepared food 4/6. In some embodiments, feet 18 are provided to raise the food preparation implement 10 and to help prevent it from sliding. These feet 18 are typically made of a rubber material. Although the food preparation implement 10 is made of any suitable material, it is preferred that the material be stiff and clear or translucent so as to provide a view of the contents for measuring purposes. Materials such as plastic or glass are anticipated as well as wood, metal, etc.

In the embodiment shown in FIG. 1, the open end 14 of the food preparation implement 10 is curved to mate with the curved edge of some cutting boards 8. In other embodiments, the open end 14 of the food preparation implement 10 form other shapes as known in the industry.

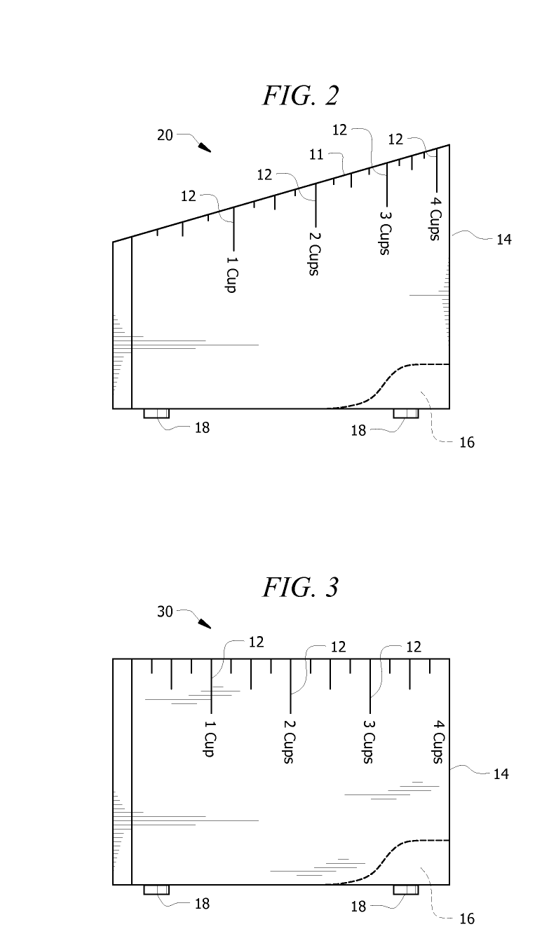

Referring to FIG. 2, a side cut-away view of a first embodiment of the present invention is shown. The food preparation implement 20 is shown in position to accept the prepared food 6. In this embodiment, the food preparation implement 20 is taller at an end closest to the cutting board 8 as shown by the sloping top edge 11 to provide greater accuracy of measurement for smaller amounts, since the gradients 12 are spaced further apart at the narrow end than at the wide end that interfaces with the cutting board 8. The liquid barrier 16 helps keep the liquid within the food preparation implement 20 until the contents are poured into another container (not shown). In the preferred embodiment, the liquid barrier 16 is curved (as shown) for ease of use and cleaning. In other embodiments, the liquid barrier 16 is rectangular (not shown), forming approximately a right angle where the liquid barrier 16 meets the side of the food preparation implement 10.

To measure the volume of the food 6 already prepared, the food preparation implement 20 is turned until the opening 14 is in an upward position and the food 6 and liquid 4 on the bottom, whereby the gradients 12 indicate the volume of prepared food. In some embodiments, feet 18 are provided to raise the food preparation implement 20 and to help prevent it from sliding. These feet 18 are typically made of a rubber material. The food preparation implement 20 is made of any suitable material, preferably a stiff and clear or translucent material so as to provide a view of the contents for measuring purposes. Materials such as plastic or glass are anticipated as well as wood, metal, etc.

In the embodiment shown in FIG. 2, the open end 14 of the food preparation implement 20 is straight to mate with the straight edge of some cutting boards.

Referring to FIG. 3, a side cut-away view of a second embodiment of the present invention is shown. The food preparation implement 30 is shown in position to accept the prepared food 6. In this embodiment, the food preparation implement 30 is rectangular. As with the previous embodiments, the liquid barrier 16 helps keep the liquid within the food preparation implement 30 until the contents are poured into another container (not shown). To measure the volume of the food 6 already prepared, the food preparation implement 30 is turned until the opening 14 is in an upward position and the food 6 and liquid 4 on the bottom, whereby the gradients 12 indicate the volume of prepared food. In some embodiments, feet 18 are provided to raise the food preparation implement 30 and to help prevent it from sliding. These feet 18 are typically made of a rubber material. The food preparation implement 30 is made of any suitable material, preferably a stiff and clear or translucent material so as to provide a view of the contents for measuring purposes. Materials such as plastic or glass are anticipated as well as wood, metal, etc.

In the embodiment shown in FIG. 3, the open end 14 of the food preparation implement 30 is straight to mate with the straight edge of some cutting boards, although other edge shapes are anticipated.

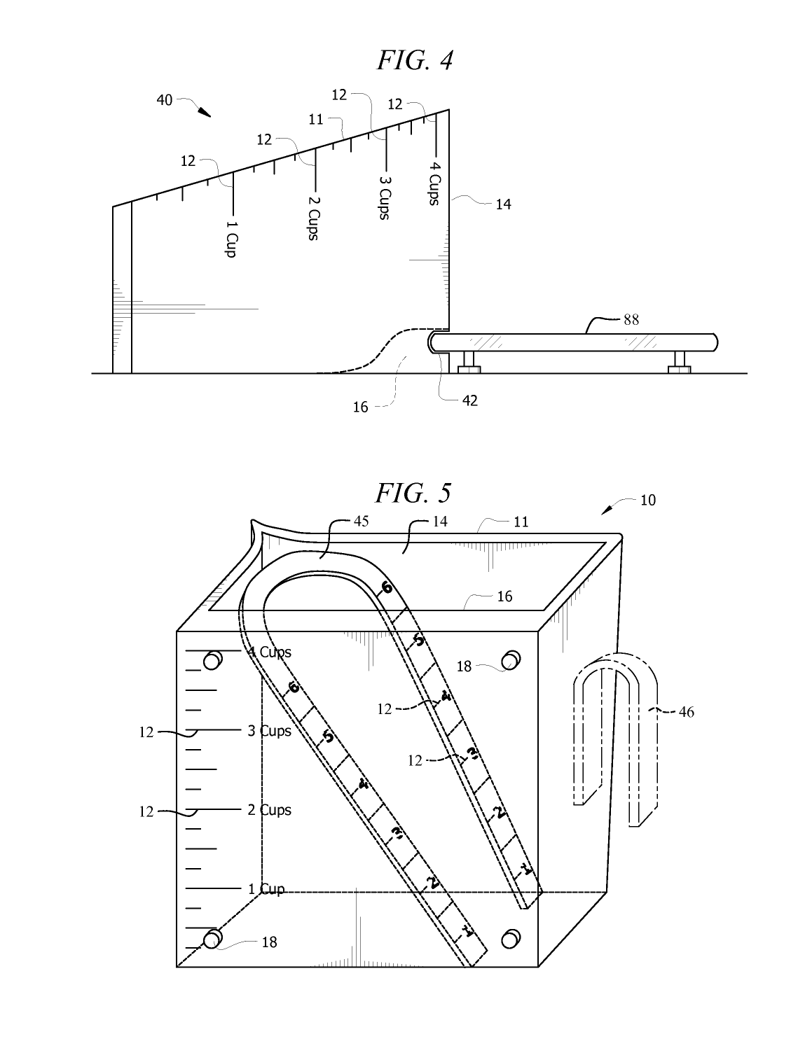

Referring to FIG. 4, a side cut-away view of a third embodiment of the present invention is shown. The food preparation implement 40 is shown in position to accept the prepared food 6. In this embodiment, the food preparation implement 40 is taller at an end closest to the cutting board 8 as shown by the sloping top edge 11 to provide greater accuracy of measurement for smaller amounts, since the gradients 12 are spaced further apart at the narrow end than at the wide end. The liquid barrier 16 helps keep the liquid within the food preparation implement 40 until the contents are poured into another container (not shown). To measure the volume of the food 6 already prepared, the food preparation implement 40 is turned until the opening 14 is in an upward position and the food 6 and liquid 4 on the bottom, whereby the gradients 12 indicate the volume of prepared food. The food preparation implement 40 is made of any suitable material, preferably a stiff and clear or translucent material so as to provide a view of the contents for measuring purposes. Materials such as plastic or glass are anticipated as well as wood, metal, etc.

In the embodiment shown in FIG. 4, the open end 14 of the food preparation implement 40 is straight and has a receptacle 42 for mating with the edge of some cutting boards 88, particularly tempered glass cutting boards 88.

Referring to FIG. 5, a side cut-away view of a fourth embodiment of the present invention is shown. The food preparation implement 10 is shown in position to measure the amount of prepared food contained there within. To measure the volume of the food 6 already prepared, the food preparation implement 10 is turned until the opening 14 is in an upward position and the food 6 and liquid 4 on the bottom, whereby the gradients 12 indicate the volume of prepared food. In this embodiment, a raised surface gradient scale 45 is provided to make measuring easier and more accurate.

In some embodiments, feet 18 are provided to raise the food preparation implement 10 and to help prevent it from sliding. These feet 18 are typically made of a rubber material. Also, in some embodiments, a handle 46 is provided to improve the handling of the food preparation implement 10. The food preparation implement 10 is made of any suitable material, preferably a stiff and clear or translucent material so as to provide a view of the contents for measuring purposes. Materials such as plastic or glass are anticipated as well as wood, metal, etc.

In the embodiment shown in FIG. 5, the open end 14 of the food preparation implement 10 is straight to mate with the straight edge of some cutting boards.

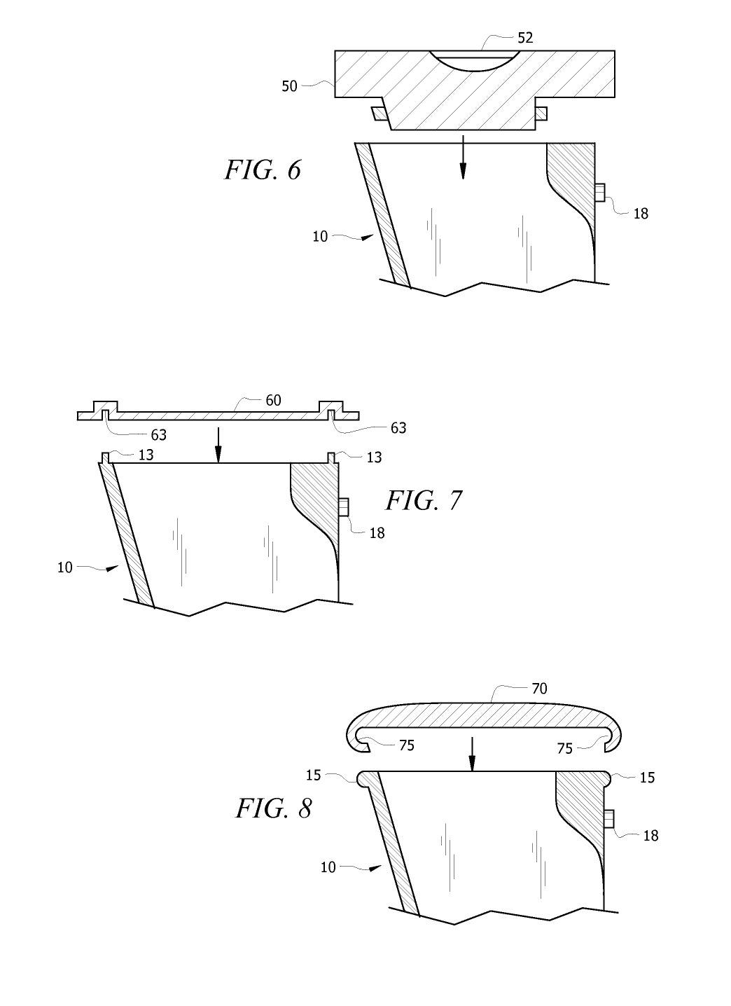

Referring to FIG. 6, a side cut-away view of a first optional lid of the present invention is shown. It is anticipated that the food preparation implement 10/20/30/40 will also be used to store prepared food before cooking. For such, an optional lid 50 provides an air-tight closure for the food preparation implement 10/20/30/40. In some embodiments, the lid has a handle 52.

Referring to FIG. 7, a side cut-away view of a second optional lid of the present invention is shown. It is anticipated that the food preparation implement 10/20/30/40 will also be used to store prepared food before cooking. For such, an optional lid 60 provides an air-tight closure for the food preparation implement 10/20/30/40. The lid 60 has recesses 63 that accept lips 13 on the food preparation implement 10/20/30/40 as known in the industry.

Referring to FIG. 8, a side cut-away view of a third optional lid of the present invention is shown. It is anticipated that the food preparation implement 10/20/30/40 will also be used to store prepared food before cooking. For such, an optional lid 70 provides an air-tight closure for the food preparation implement 10/20/30/40. The lid 70 has overhang lips 75 that overlap mating edges 15 on the food preparation implement 10/20/30/40 as known in the industry.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A food preparation implement comprising:
a food preparation container having sides and an open end, the open end adapted to interface with a cutting board; and
a liquid barrier on a bottom, inner side of the food preparation container near the open end, whereas the liquid barrier forms a liquid-tight barrier preventing prepared food and liquid from exiting the food preparation container while the food preparation container is in use.

2. The food preparation implement of claim 1, wherein the food preparation container is made from a translucent material.

3. The food preparation implement of claim 1, wherein the food preparation container is marked with gradients for measuring the volume of prepared food contained there within.

4. The food preparation implement of claim 1, further comprising a receptacle on the open end for mating with the cutting board.

5. The food preparation implement of claim 1, wherein the food preparation container has rubber feet on a side that interfaces with a counter surface.

6. The food preparation implement of claim 1, further comprising a handle affixed to one of the sides.

7. The food preparation implement of claim 1, further comprising an air-tight lid, the air-tight lid adapted to seal the open end of the food preparation container.

8. A method of preparing food comprising:
providing a cutting board for cutting food;
providing a food preparation container, the food preparation container having sides and an open end, the open end adapted to interface with the cutting board; the food preparation container having a liquid barrier on a bottom, inner side of the food preparation container near the open end, whereas the liquid barrier forms a liquid-tight barrier preventing prepared food and liquid from exiting the food preparation container while the food preparation container is in use;
cutting food on the cutting board;
pushing the food into the food preparation container, whereas the liquid barrier prevents the food and any liquid from escaping from the food preparation container.

9. The method of preparing food of claim 8, wherein the food preparation container is made from a translucent material.

10. The method of preparing food of claim 8, further comprising measuring an amount of prepared food by standing the food preparation container on end and using gradients for measuring the volume of the prepared food contained there within.

11. The method of preparing food of claim 8, wherein the food preparation container has rubber feet on a side that interfaces with a counter surface.

12. The method of preparing food of claim 8, further comprising a handle affixed to one of the sides.

13. The method of preparing food of claim 8, further comprising the step of enclosing the food preparation container by attaching an air-tight lid, the air-tight lid adapted to seal the open end of the food preparation container.

14. A food preparation implement comprising:
a means for containing prepared food, the means for containing prepared food having sides and an open end, the open end adapted to interface with a cutting board; and
a means for preventing liquid from escaping the means for containing the prepared food, the means for preventing the liquid from escaping located on a bottom, inner side of the means for containing the prepared food near the open end, whereas the means for preventing the liquid from escaping forms a liquid-tight barrier preventing the prepared food and the liquid from exiting the means for containing the prepared food while the means for containing the prepared food is in use.

15. The food preparation implement of claim 14, wherein the means for containing the prepared food is made from a translucent material.

16. The food preparation implement of claim 14, further comprising a means for measuring the volume of the prepared food.

17. The food preparation implement of claim 16, wherein the means for measuring the volume of the prepared food is gradients on a side surface of the means for containing the prepared food.

18. The food preparation implement of claim 14, wherein the means for containing the prepared food has rubber feet on a side that interfaces with a counter surface.

19. The food preparation implement of claim 14, further comprising a handle affixed to the means for containing the prepared food.

20. The food preparation implement of claim 14, further comprising an air-tight lid, the air-tight lid adapted to seal the open end of the means for containing the prepared food.
